(19) United States
(12) Patent Application Publication
(10) Pub. No.: US 2016/0253016 A1
(43) Pub. Date: Sep. 1, 2016

(54) ELECTRONIC DEVICE AND METHOD FOR DETECTING INPUT ON TOUCH PANEL

(71) Applicant: Samsung Electronics Co., Ltd., Gyeonggi-do (KR)

(72) Inventor: Chang Jin KIM, Gyeonggi-do (KR)

(21) Appl. No.: 15/054,269

(22) Filed: Feb. 26, 2016

(30) Foreign Application Priority Data
Feb. 27, 2015 (KR) 10-2015-0028664

(51) Int. Cl. G06F 3/041

(52) U.S. Cl. CPC G06F 3/0412; G06F 2203/04106; G06F 2203/04108

(57) ABSTRACT

An electronic device comprising: a touch panel; and a touch sensing controller configured to: operate at least one first area of the touch panel in accordance with a first sensitivity configuration setting; and operate at least one second area of the touch panel in accordance with a second sensitivity configuration setting that is different from the first sensitivity configuration setting. The at least one first area is adjacent to at least one side edge of the touch panel and a touch sensitivity of the at least one first area is lower than the touch sensitivity of the at least one second area.

### CLAIM OF PRIORITY

This application claims the benefit under 35 U.S.C. §119(a) of a Korean patent application filed on Feb. 27, 2015 in the Korean Intellectual Property Office and assigned Serial number 10-2015-0028664, the entire disclosure of which is hereby incorporated by reference.

### TECHNICAL FIELD

The present disclosure relates to electronic devices, in general, and more particularly to an electronic device and method for detecting input on a touch panel.

### BACKGROUND

With the recent development of information communication technology, a network device such as a base station is installed throughout the country and an electronic device allows a user to use a network freely anywhere in the country by transmitting/receiving data to/from another electronic device through the network.

Various kinds of electronic devices provide various functions according to recent digital convergence trends. For example, in addition to the purpose for calls, smartphones support internet access functions by using the network, music or video playback functions, and picture or video capturing functions by using an image sensor.

Additionally, the electronic device includes various sensors and provides various functions for a user by processing information obtained from the sensors. For example, an electronic device includes a touch panel to detect a user's finger on a touch panel as a touch input and provide a function corresponding to the touch input based on the position of the finger.

A conventional electronic device uses the entire area of a touch panel with the same sensitivity. Accordingly, a conventional electronic device does not recognize a touch inputted near a bezel as a user input.

### SUMMARY

According to aspects of the disclosure, an electronic device is provided comprising: a touch panel; and a touch sensing controller configured to: operate at least one first area of the touch panel in accordance with a first sensitivity configuration setting; and operate at least one second area of the touch panel in accordance with a second sensitivity configuration setting that is different from the first sensitivity configuration setting. The at least one first area is adjacent to at least one side edge of the touch panel and a touch sensitivity of the at least one first area is lower than the touch sensitivity of the at least one second area.

According to aspects of the disclosure, a method is provided comprising: operating at least one first area of a touch panel of an electronic device in accordance with a first sensitivity configuration setting; and operating at least one second area of the touch panel in accordance with a second sensitivity configuration setting that is different from the first sensitivity configuration setting. The at least one first area is adjacent to at least one side edge of the touch panel and a touch sensitivity of the at least one first area is lower than the touch sensitivity of the at least one second area.

According to aspects of the disclosure, a non-transitory computer-readable medium is provided that stores one or more processor-executable instructions which when executed by at least one processor of an electronic device cause the at least one processor to execute a method comprising the steps of: operating at least one first area of a touch panel of an electronic device in accordance with a first sensitivity configuration setting; and operating at least one second area of the touch panel in accordance with a second sensitivity configuration setting that is different from the first sensitivity configuration setting. The at least one first area is adjacent to at least one side edge of the touch panel and a touch sensitivity of the at least one first area is lower than the touch sensitivity of the at least one second area.

### BRIEF DESCRIPTION OF THE DRAWINGS

FIG. 1 is a block diagram of an example of an electronic device, according to various embodiments of the present disclosure;

FIG. 2 is a diagram of an example of a touch panel, according to various embodiments of the present disclosure;

FIG. 3 is a graph illustrating the input object detection times for a first area and a second area of the touch panel of FIG. 2, according to various embodiments of the present disclosure;

FIG. 4 is a diagram of an example of an electronic device having a curved display, according to various embodiments of the present disclosure;

FIG. 5 is a diagram illustrating an example of a technique for disabling automatic screen rotation, according to various embodiments of the present disclosure;

FIG. 6 is a diagram illustrating an example of a technique for enabling automatic screen rotation, according to various embodiments of the present disclosure;

FIG. 7 is a diagram of an example of a technique for automatically deactivating a screen of an electronic device, according to various embodiments of the present disclosure;

FIG. 8 is a diagram of an example of a technique for automatically activating a screen of an electronic device, according to various embodiments of the present disclosure;

FIG. 9 is a diagram of an example of a technique for capturing images, according to various embodiments of the present disclosure;

FIG. 10 is a flowchart of an example of a process, according to various embodiments of the present disclosure; and

FIG. 11 is a block diagram of an example of an electronic device, according to various embodiments of the present disclosure.

### DETAILED DESCRIPTION

Hereinafter, various embodiments of the present disclosure are disclosed with reference to the accompanying drawings. However, this does not limit various embodiments of the present disclosure to a specific embodiment, and it should be understood that the present disclosure covers all the modifications, equivalents, and/or alternatives of this disclosure provided they come within the scope of the appended claims and their equivalents. With respect to the descriptions of the drawings, like reference numerals refer to like elements.

The term “include,” “comprise,” and “have”, or “may include,” or “may comprise” and “may have” used herein indicates disclosed functions, operations, or existence of elements but does not exclude other functions, operations or elements.

For instance, the expression “A or B”, or “at least one of A or/and B” may indicate include A, B, or both A and B. For instance, the expression “A or B”, or “at least one of A or/and B” may indicate (1) at least one A, (2) at least one B, or (3) both at least one A and at least one B.

The terms such as “1st”, “2nd”, “first”, “second”, and the like used herein may refer to modifying various different elements of various embodiments of the present disclosure, but do not limit the elements. For instance, “a first user device” and “a second user device” may indicate different users regardless of the order or the importance. For example, a first component may be referred to as a second component and vice versa without departing from the scope of the present disclosure.

In various embodiments of the present disclosure, it will be understood that when a component (for example, a first component) is referred to as being “(operatively or communicatively) coupled with/to” or “connected to” another component (for example, a second component), the component may be directly connected to the other component or connected through another component (for example, a third component). In various embodiments of the present disclosure, it will be understood that when a component (for example, a first component) is referred to as being “directly connected to” or “directly access” another component (for example, a second component), another component (for example, a third component) does not exist between the component (for example, the first component) and the other component (for example, the second component).

The expression “configured to” used in various embodiments of the present disclosure may be interchangeably used with “suitable for”, “having the capacity to”, “designed to”, “adapted to”, “made to”, or “capable of” according to a situation, for example. The term “configured to” may not necessarily mean “specifically designed to” in terms of hardware. Instead, the expression “a device configured to” in some situations may mean that the device and another device or part are “capable of”. For example, “a processor configured (or set) to perform A, B, and C” in a phrase may mean a dedicated processor (for example, an embedded processor) for performing a corresponding operation or a generic-purpose processor (for example, a CPU or application processor) for performing corresponding operations by executing at least one software program stored in a memory device.

Terms used in various embodiments of the present disclosure are used to describe specific embodiments of the present disclosure and are not intended to limit the scope of other embodiments. The terms of a singular form may include plural forms unless they have a clearly different meaning in the context. Otherwise indicated herein, all the terms used herein, which include technical or scientific terms, may have the same meaning that is generally understood by a person skilled in the art. In general, the terms defined in the dictionary should be considered to have the same meaning as the contextual meaning of the related art, and, unless clearly defined herein, should not be understood abnormally or as having an excessively formal meaning. In any cases, even the terms defined in this specification cannot be interpreted as excluding embodiments of the present disclosure.

According to various embodiments of the present disclosure, electronic devices, as a device for supporting a touch screen, may include at least one of smartphones, tablet personal computers (PCs), mobile phones, video phones, electronic book (e-book) readers, desktop personal computers (PCs), laptop personal computers (PCs), netbook computers, personal digital assistants (PDAs), portable multimedia player (PMPs), MP3 players, cameras, and wearable devices.

Hereinafter, an electronic device according to various embodiments of the present disclosure will be described in more detail with reference to the accompanying drawings. The term “user” in this disclosure may refer to a person using an electronic device or a device using an electronic device (for example, an artificial intelligent electronic device).

Additionally, it will be described with reference to the accompanying drawings that an electronic device is a smartphone according to various embodiments of the present disclosure.

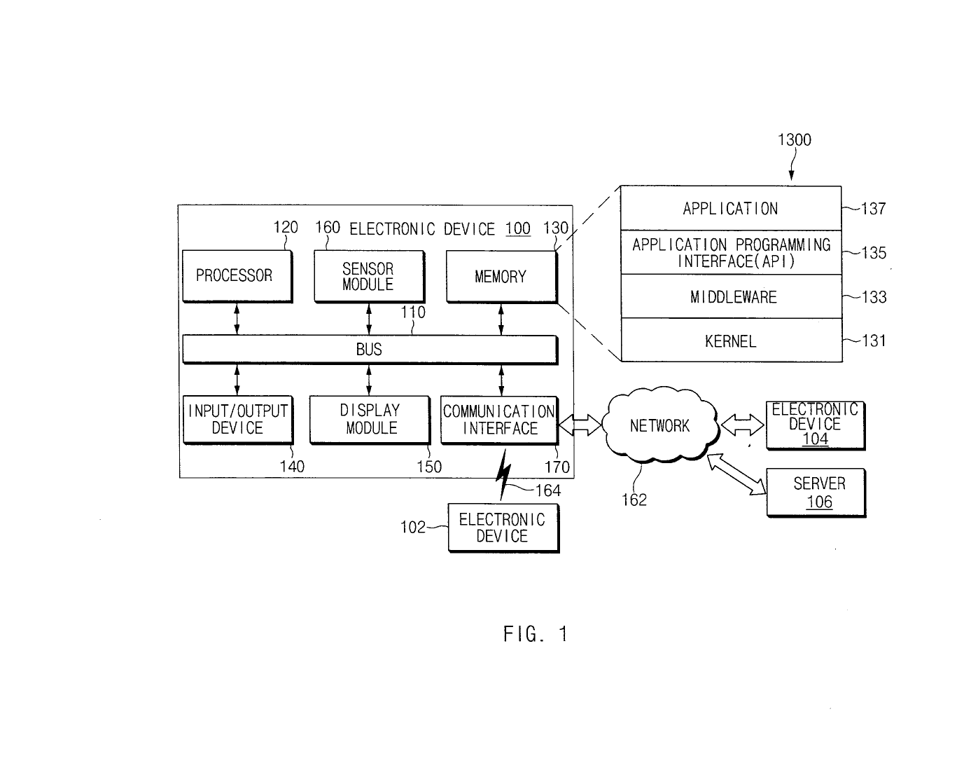

FIG. 1 is a block diagram of an example of an electronic device, according to various embodiments of the present disclosure. The electronic device 100 may include a bus 110, a processor 120, a memory 130, an input/output device 140, a display module 150, a sensor module 160, and a communication interface 170. According to an embodiment of the present disclosure, the electronic device 100 may omit at least one of the components or may additionally include a different component.

The configuration of the electronic device 100 shown in FIG. 1 is merely one implementation example of the present disclosure and various modifications are possible. For example, although not shown in FIG. 1, the electronic device 100 may further include a communication module for communicating with the outside. In this case, the electronic device 100 for performing communication may use a wired/wireless network and the network may include cellular network and data network. Additionally, the electronic device 100 may further include a user interface for receiving a certain instruction or information from a user. In this case, the user interface may be an input device such as a keyboard, a mouse, and so on in general and may be a Graphical User Interface (GUI) displayed on the screen of the electronic device 100.

The bus 110, for example, may include a circuit for connecting the components 110 to 160 to each other and delivering a communication (for example, control message and/or data) therebetween.

The processor 120, for example, may control at least one another component of the electronic device 100. Additionally, the processor 120 may load instructions or data, which are received from at least one of other components, from the memory 300 and process them and may store various data in the memory.

The processor 120 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. Additionally or alternatively, according to various embodiments of the present disclosure, the processor 120 may include at least one of a central processing unit (CPU), an Application Processor (AP), a touch sensing controller, a touch screen panel integrated circuit (TSP IC), and a microcontroller unit (MCU) such as a sensor hub MCU.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. The memory 130 may include volatile and/or nonvolatile memory. The memory 130, for example, may store instructions or data relating to at least one another component of the electronic device 100. According to various embodiments of the present disclosure, the memory 130 may store software and/or a program 1300. The program 1300 may include a kernel 131, a middleware 133, an application programming interface (API) 135, and/or an application program (or application) 137. At least part of the kernel 131, the middleware 133, and the API 135 may be called an operating system (OS).

The kernel 131, for example, may control or manage system resources (for example, the bus 110, the processor 120, the memory 130, and so on) used for performing operations or functions implemented in other programs (for example, the middleware 133, the API 135, or the application program 137). Additionally, the kernel 131 may provide an interface for controlling or managing system resources by accessing an individual component of the electronic device 101 from the middleware 133, the API 135, or the application program 137.

The middleware 133, for example, may serve as an intermediary role for exchanging data as the API 135 or the application program 137 communicates with the kernel 131.

Additionally, the middleware 133 may process at least one job request received from the application program 137 according to a priority. For example, the middleware 133 may assign to at least one application program 137 a priority for using a system resource (for example, the bus 110, the processor 120, or the memory 130) of the electronic device 101. For example, the middleware 133 may perform scheduling or load balancing on the at least one job request by processing the at least one job request according to the priority assigned to the at least one job request.

The API 135, as an interface for allowing the application program 137 to control a function provided by the kernel 131 or the middleware 133, may include at least one interface or function (for example, an instruction) for file control, window control, image processing, or character control.

The input/output device 140 may receive instructions or data from a user or another external device or may output instructions or data received from another component(s) of the electronic device 100 to a user or another external device. The input/output of the instructions or data may be performed through an input/output interface (not shown). The input/output interface, for example, may serve as an interface for delivering instructions or data inputted by a user or received from an external device to another component(s) of the electronic device 100.

According to various embodiments of the present disclosure, the input/output device 140, for example, may include a touch panel as an input device. The touch panel, for example, may receive a touch input such as a user's finger or a stylus pen. The touch input may include a hovering input in addition to input that is based on physical contact. The touch panel may recognize a touch input through at least one of capacitive, resistive, infrared, or ultrasonic methods. Additionally, the touch panel may further include a control circuit. In the case of the capacitive method, both direct touch and proximity recognition are possible. The touch panel may further include a tactile layer.

The input/output device 140, for example, may include a screen as an output device. The screen, for example, may include a liquid crystal display (LCD), a light-emitting diode (LED) display, an organic light-emitting diode (OLED) display, microelectromechanical systems (MEMS) display, or an electronic paper display. The display 160 may display various contents (for example, text, image, video, icon, symbol, and so on) to a user. The screen may include a touch screen including the touch panel and for example, may receive a touch, gesture, proximity, or hovering input by using an electronic pen or a user's body part.

Besides that, the input/output device 140 may further include various devices such as a speaker, a microphone, a receiver, and so on but additional descriptions are omitted.

The display module 150 may display various contents (for example, application execution screens, texts, images, videos, icons, symbols, and so on) on the screen. The displaying of the various contents may be performed through a control of the processor 120. The display module 150 may be an input/output interface for the screen.

The sensor module 160 measures physical quantities or detects an operating state of the electronic device 100 by using at least one sensor, thereby converting the measured or detected information into electrical signals. The at least one sensor, for example, may include a gyro sensor, an acceleration sensor, a motion recognition sensor, an infrared (IR) sensor, and an image sensor.

The communication interface 170, for example, may set a communication between the electronic device 101 and an external device (for example, the first external electronic device 102, the second external electronic device 104, or the server 106). For example, the communication interface 170 may communicate with an external device (for example, the second external electronic device 104 or the server 106) in connection to the network 162 through wireless communication or wired communication.

The wireless communication, as a cellular communication protocol, may use at least one of long-term evolution (LTE), LTE Advance (LTE-A), code division multiple access (CDMA), wideband CDMA (WCDMA), universal mobile telecommunications system (UMTS), Wireless Broadband (WiBro), Global System for Mobile Communications (GSM), and so on. Additionally, the wireless communication, for example, may include a short-range communication 164. The short range communication 164, for example, may include at least one of wireless fidelity (WiFi), Bluetooth (BT), near field communication (NFC), global positioning system (GPS), and so on. The GNSS may include at least one of GPS, GLONASS, and Beidou Navigation Satellite System (hereinafter referred to as Beidou) and Galileo, that is, the European global satellite-based navigation system. Hereinafter, GPS and GNSS may be interchangeably used. The wired communication, for example, may include at least one of universal serial bus (USB), high definition multimedia interface (HDMI), recommended standard 232 (RS-232), plain old telephone service (POTS), and so on. The network 162 may include a telecommunications network, for example, at least one of a computer network (for example, LAN or WAN), the Internet, and a telephone network.

Each of the first and second external electronic devices 102 and 104 may have the same or different type from the electronic device 100. According to an embodiment of the present disclosure, the server 106 may include a group of one or more servers. According to various embodiments of the present disclosure, all or part of operations executed on the electronic device 100 may be executed on another one or more electronic devices (for example, the first external electronic device 102, the second external electronic device 104, or the server 106). According to an embodiment of the present disclosure, when the electronic device 100 performs a certain function or service automatically or by a request, it may request at least part of a function relating thereto from another electronic device (for example, the first external electronic device 102, the second external electronic device 104, or the server 106) instead of or in addition to executing the function or service by itself. The other electronic devices (for example, the first external electronic device 102, the second external electronic device 104, or the server 106) may execute the requested function or an additional function and may deliver an execution result to the first electronic device 100. The electronic device 100 may provide the requested function or service as it is or by processing the received result additionally. For this, for example, cloud computing, distributed computing, or client-server computing technology may be used.

It is apparent to those skilled in the art that each of the bus 110, the processor 120, the memory 130, the input/output device 140, the display module 150, the sensor module 160, and the communication interface 170 may be implemented separately in the electronic device 100 or at least one thereof may be implemented integrally.

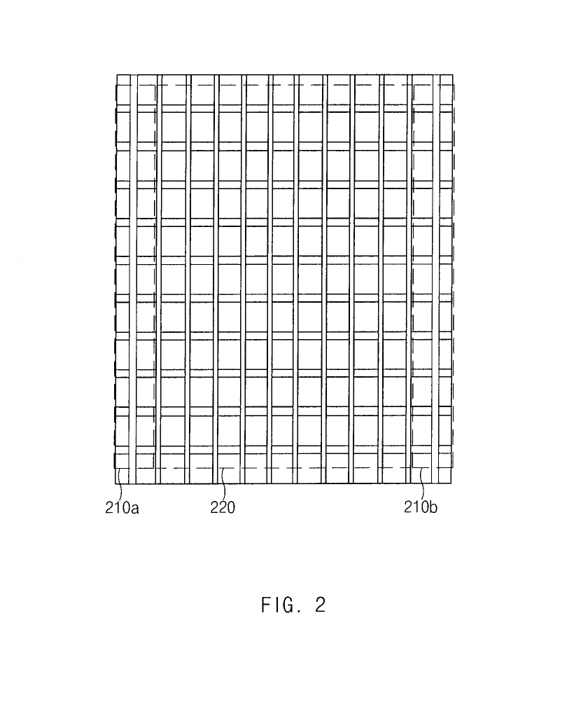

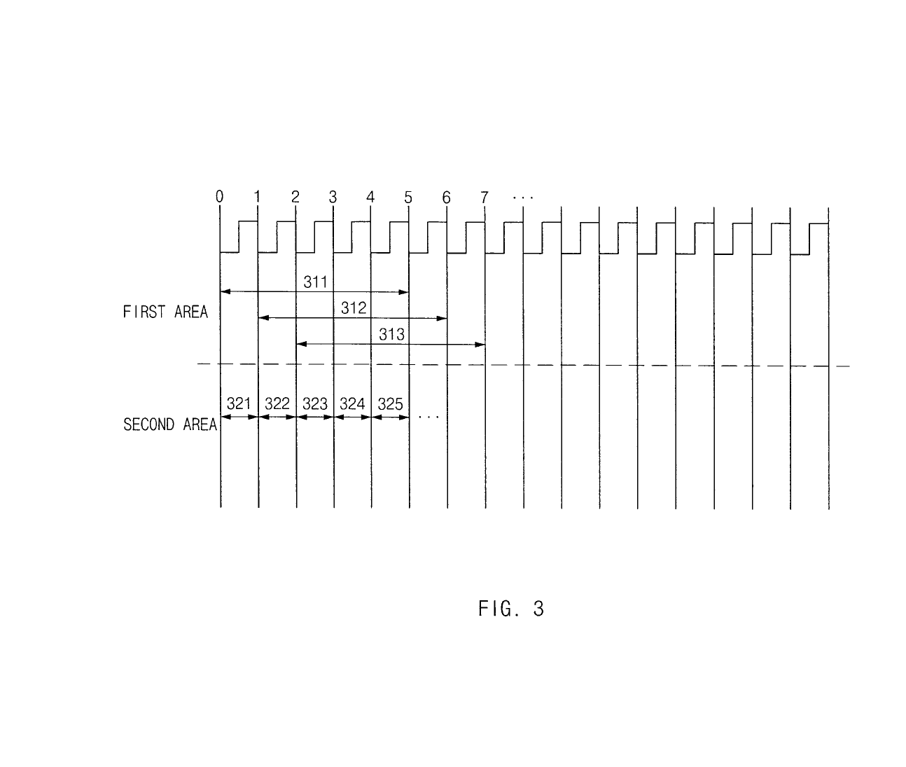

Hereinafter, referring to FIGS. 2 and 3, an operation of the processor 120 to detect at least one input object by using the above-mentioned at least one component will be described. The input object may mean the user's finger or the stylus pen.

FIG. 2 is a diagram of an example of a touch panel, according to various embodiments of the present disclosure. More particularly, FIG. 2 depicts a touch panel 200 having a first area 210a, a second area 220, and a third area 210b.

Referring to FIG. 2, the touch panel 200 may include the first area 210a, the second area 220, and the third area 210b. According to various embodiments of the present disclosure, the first area 210a and the third area 210b of the touch panel 200, for example, may be different end parts of the touch panel 200. According to various embodiments of the present disclosure, the second area 220, for example, may include a central portion of the touch panel 220. At least one wire may be included in the each area. Although it is shown in FIG. 2 that the first area 210a and the third area 210b are disposed at the left and right of the touch panel 200, respectively, according to various embodiments of the present disclosure, the first area 210a and the third area 210b may be disposed at the upper end and lower end of the touch panel 200, respectively.

According to various embodiments of the present disclosure, the processor 120 (for example, the TSP IC) may recognize at least one input object that contacts or approaches the touch panel 200. For example, when an input object contacts a side surface of the housing of the electronic device 100, a touch sensor may generate a first signal. Then, when the input object contacts a horizontal surface (for example, an upper surface of the housing) of the housing, the touch sensor may generate a second signal. The TSP IC may receive a first signal and a second signal from the touch sensor and calculate the coordinates of the object based on the received first and second signals. The at least one approaching input object may include at least one input object disposed within a specified distance from the touch panel 200 in order for an available hovering input.

According to various embodiments of the present disclosure, when at least one input object contacts or approaches the first area 210a or the third area 210b of the touch panel 200, the processor 120 may recognize the at least one input object in accordance with a first configuration setting (e.g., first sensitivity) and when the at least one input object contacts or approaches the second area 220 of the touch panel 200, the processor 120 may recognize the at least one input object in accordance with a second configuration setting that is different from the first configuration setting (e.g., a second sensitivity different from the first sensitivity). According to various embodiments of the present disclosure, the first sensitivity may have a higher value than the second sensitivity. In this case, the processor 120 may recognize an input properly at a side or edge of the electronic device 100. According to another embodiment of the present disclosure, the processor 120 may set the first sensitivity with a lower value than the second sensitivity in order to ignore an input at a side or edge of the electronic device 100.

According to various embodiments of the present disclosure, in order to recognize at least one input object, the processor 120 may adjust an operating frequency of the touch panel 200 for detecting an input object in the first area 210a, the second area 220, or the third area 210b. According to an embodiment of the present disclosure, the processor 120 may sample the first area 210a or the third area 210b with a first frequency. In such instances, the processor 120 may detect at least one input object by scanning the first area 210a or the third area 210b with a first sensitivity. According to an embodiment of the present disclosure, the processor 120 may control the second area 220 with a second frequency. In such instances, the processor 120 may detect at least one input object by scanning the second area 220 with a second sensitivity. For example, the processor 120 may allow the first area 210a or the third area 210b to recognize at least one input object in a 0.11 ms period and also allow the second area 220 to detect at least one input object in a 0.22 ms period. The processor 120 may recognize an input object by accumulating a capacitance value between a touch sensor and the input object during a corresponding period. Accordingly, when a period for detecting an object is longer, the processor 120 may become more likely to recognize the input object properly. A sensitivity for detecting the input object, for example, may be 60 pico-farads (pf).

According to other various embodiments of the present disclosure, the processor 120 may vary a detection time for recognizing at least one input object through a method of adjusting the first sensitivity and the second sensitivity. For example, the processor 120 may allow the first area 210a or the third area 210b to recognize at least one input object during a 0.5 ms period and also allow the second area 220 to detect at least one input object during a 0.1 ms period.

FIG. 3 is a graph illustrating the input object detection times for the first and second areas of the touch panel of the present disclosure, according to various embodiments of the present disclosure. As illustrated in FIG. 3, according to various embodiments of the present disclosure, the processor 120 may detect at least one input object during five cycles through the first area 210a or the third area 210b, for example. According to an embodiment of the present disclosure, the processor 120 may detect the at least one input object during one cycle through the second area 220. As mentioned above, an operation for increasing the number of cycles for detecting an input object may be regarded as increasing the resolution of a touch panel.

According to an embodiment of the present disclosure, the processor 120 may lengthen a time for detecting at least one input object in the first area 210a or the third area 210b, compared to the second area 220. In such instances, a sensitivity for recognizing the at least one input object in the first area 210a or the third area 210b may be greater than that of the second area 220. According to an embodiment of the present disclosure, when at least one input object applies a hovering input at an arbitrary position of the touch panel 200, the processor 120 may fail to detect the at least one input object through the second area 220, but may successfully detect the at least one input object through the first area 210a or the third area 210b.

According to an embodiment of the present disclosure, when a user grips the electronic device 100, a user's palm may support one surface of the electronic device 100 and a user's finger may grip a side surface of the electronic device 100. For example, when a user's finger does not directly contact the touch panel 200, the processor 120 may detect whether there is a user's grip by recognizing the user's finger as a hovering input through the first area 210a or the third area 210b.

According to an embodiment of the present disclosure, the processor 120 may detect whether an input object approaches on the touch panel 200 by accumulating change amounts in current value or capacitance value. For example, when an input object approaches a touch sensor in the touch panel 200, capacitance occurs between the touch sensor and the input object. At this point, when the sum of capacitances accumulated during one period is greater than a predetermined value, the processor 120 may determine that the input object has come in contact (e.g., physical or electrical) with the touch panel 200.

According to an embodiment of the present disclosure, whether at least one input object approaches during five cycles in the first area 210a or third area 210b of the touch panel 200 may be detected by accumulating change amounts of current or capacitance. Additionally or alternatively, according to an embodiment of the present disclosure, the processor 120 may detect whether at least one input object approaches for one cycle in the second area 220 of the touch panel 200 by accumulating change amounts in current value or capacitance value. That is, the processor 120 may increase the sensitivity of the first area 210a or the third area 210b in comparison to the sensitivity of the second area 220 by varying the number of cycles for detecting an input object that approaches the first area 210a or the third area 210b and the number of cycles for detecting an input object that approaches the second area 220.

In instances in which at least one input object is placed on the first area 210a or the third area 210b, a delay by four cycles may occur before the input object is detected, in comparison to when the input object is placed on the second area 220.

Although it is shown in FIG. 3 that the processor 120 detects at least one input object during five cycles through the first area 210a or the third area 210b, a time for detecting at least one input object is not limited to the five cycles. For example, the processor 120, for example, may detect at least one input object by accumulating change amounts in current value or capacitance value during three cycles. According to various embodiments of the present disclosure, the touch panel 200 may be a self-type touch panel or a mutual-type touch panel. According to an embodiment of the present disclosure, the touch control device 200 may be one of a self-type touch panel and a mutual-type touch panel. When the touch panel 200 is a self-type touch panel, a time for detecting at least one input object in the first area 210a or the third area 210b may be three cycles and when the touch panel 200 is a mutual-type touch panel, a time for detecting at least one input object in the first area 210a or the third area 210b may be five cycles. Basically, compared to the mutual type, the self-type touch panel has better sensitivity, so that the same effect may be obtained with fewer cycles.

According to another embodiment of the present disclosure, compared to an input object on the second area 220, the processor 120 may more properly detect an input object on the first area 210a or third area 210b having a more amplified sensitivity gain than the second area 220.

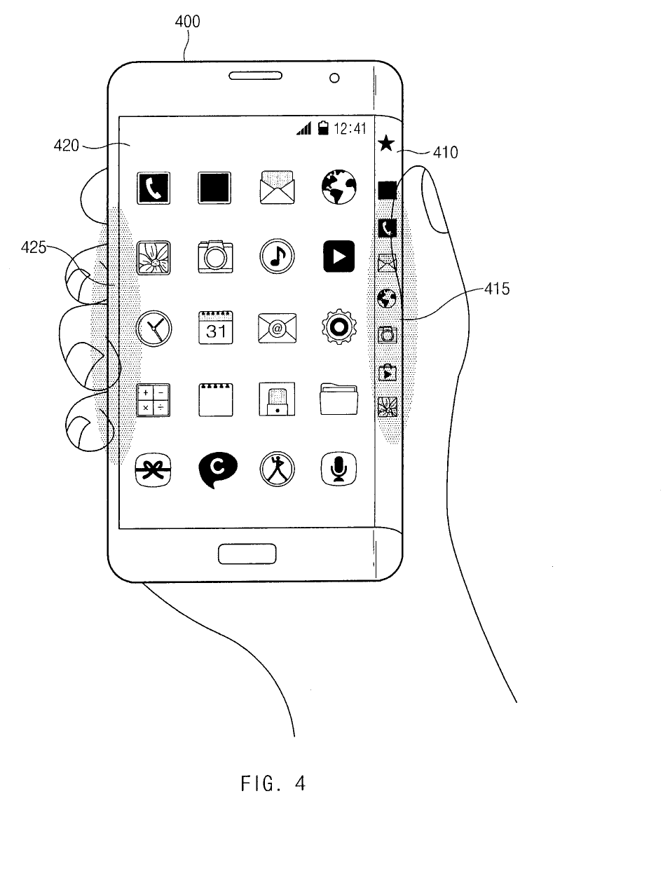

According to various embodiments of the present disclosure, the electronic device may include a curved surface in at least a part of a screen (for example, a display). In such instances, an area specific sensitivity of a touch panel may be somewhat different from that of the touch panel 200 shown in FIGS. 2 and 3. For example, when the third area 210b of FIG. 2 is located in the curved portion of the screen of the electronic device 100, a side surface of the electronic device 100 corresponding to the third area 210b may have a form (see FIG. 4) that is tilted with respect to the touch panel 200. Accordingly, when a user grips the electronic device 100, a user's finger may not be far away from the third area 210b so that the processor 120 may set a sensitivity of the third area 210b to be lower than that of the first area 210a. Even in such instances, the first area 210a and the third area 210b may have a higher sensitivity than the second area 220.

FIG. 4 is a diagram of an example of an electronic device 400 having a curved display, according to various embodiments of the present disclosure. As illustrated in FIG. 4, the electronic device 400 may include a screen having an at least partially bent first area 410 and a flat second area 420. The electronic device 400 of FIG. 4 may include a touch panel on the screen.

According to various embodiments of the present disclosure, when a user grips the electronic device 400, a user's finger may directly contact or approach at least a part 415 of a touch panel in the first area 410 and may not directly contact at least a part 425 of a touch panel of the second area 420. In such instances, in order to recognize the user's grip, the processor 120 may increase the sensitivity of an area 425 corresponding to the user's finger in the touch panel of the second area 420.

According to various embodiments of the present disclosure, an electronic device includes: a touch panel; and at least one processor functionally connected to the touch panel, and the at least one processor may specify a first area of the touch panel to be detected with a first sensitivity and specify a second area of the touch panel to be detected with a second sensitivity different from the first sensitivity.

According to various embodiments of the present disclosure, the at least one processor may detect the first area with a first frequency and detect the second area with a second frequency.

According to various embodiments of the present disclosure, the at least one processor may detect the first area with a first sensitivity gain and detect the second area with a second sensitivity gain.

According to various embodiments of the present disclosure, the at least one processor may detect the first area with a first resolution and detect the second area with a second resolution.

According to various embodiments of the present disclosure, the electronic device may further include a display functionally connected to the at least one processor and the at least one processor may receive an input through the first area and display a specified function through the display based on the received input.

According to various embodiments of the present disclosure, the at least one processor may determine whether the input is a grip for the electronic device based on the input and the specified function may be set differently based on whether the input is a grip operation for the electronic device.

According to various embodiments of the present disclosure, when the input is the grip operation for the electronic device, the at least one processor may maintain a specified function display through the display based on at least a part of the grip determination for the electronic device.

According to various embodiments of the present disclosure, when the input is not the grip operation for the electronic device, the at least one processor may prevent the specified function display after a specified time.

According to various embodiments of the present disclosure, the first area may be located in at least a part of a curved area of the touch panel.

According to various embodiments of the present disclosure, the electronic device may further include a display functionally connected to the at least one processor and the first area may be located in at least a part of a display area of the display and a second area may be located in a non-display area of the display.

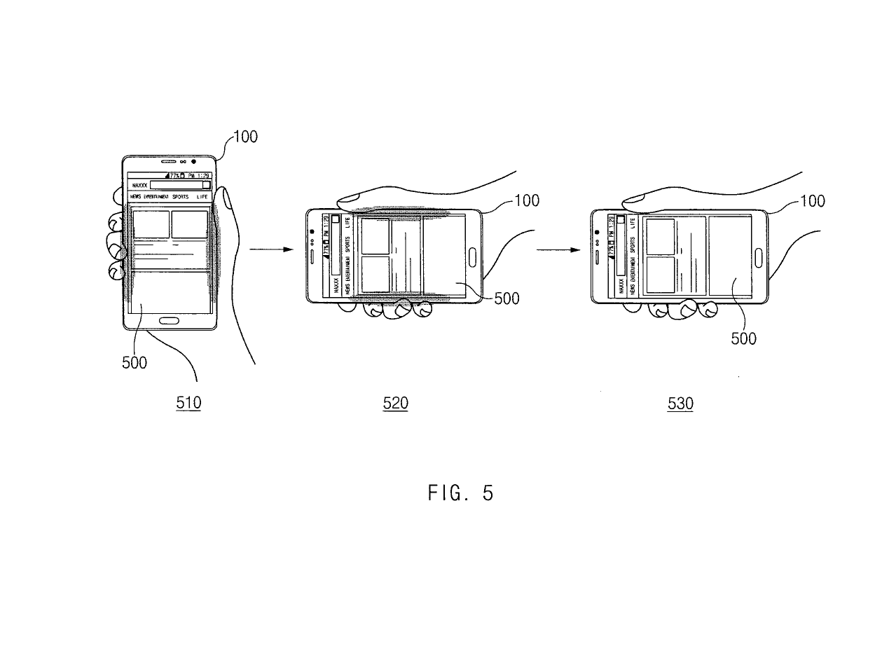

Hereinafter, an operation for recognizing a user's grip by the processor 120 will be described with reference to FIGS. 5 to 9.

FIG. 5 is a diagram illustrating an example of a technique for disabling automatic screen rotation, according to various embodiments of the present disclosure. According to various embodiments of the present disclosure, the processor 120 may provide a predetermined effect based on a value measured through the sensor module 160 while detecting at least one input object through the first area 210a or the third area 210b of the touch panel 200.

Referring to FIG. 5, the electronic device 100 may detect a user's grip state in operation 510. For example, the electronic device may detect input performed on two opposite sides of the electronic device 100 as a user's grip state. According to aspects of the disclosure, while operation 510 is performed, an internet browser 500 may be displayed on the screen of the electronic device 100.

In operation 520, the electronic device may change its orientation into a horizontal orientation with respect to the ground surface while being gripped by a user. The horizontal orientation with respect to the ground surface may mean that an angle between a line segment connecting the electronic device 100 from the ground surface and each of the thickness axis and the vertical axis of the electronic device 100 is about 90°.

According to various embodiments of the present disclosure, the electronic device 100 may detect that the electronic device 100 is rotated based on the position or angle of the electronic device 100 relative to the ground while the electronic device 100 is gripped by a user.

In operation 530, the processor 120 may determine whether the orientation of the electronic device 100 is changed as a result of the rotation based on the value measured by the sensor module 160 through gyro sensor.

Referring to operation 530, the electronic device 100 may detect that the orientation of the interface of the internet browser 500 is identical to (or otherwise matches) the orientation of the electronic device 100. For example, while the user's grip is maintained, if the angle between the electronic device 101 and the ground does not exceed a threshold value, the processor 120 may refrain from rotating the screen of the internet browser 500 that is displayed on the display of the electronic device 100.

If a user moves while gripping the electronic device 100, according to a user's arm, an angle of the electronic device 100 with respect to the ground surface may change repeatedly. For example, if a user walk or runs while gripping the electronic device 100 in a state that the screen of the electronic device 100 is turned on, the screen displayed on the screen of the electronic device 100 may continue to rotate and thus, consume a lot of power. Accordingly, according to various embodiments of the present disclosure, by temporarily locking the auto-rotation function of the electronic device 100, power consumption may be reduced.

According to various embodiments of the present disclosure, a method of determining a user's grip state may vary. For example, when there is a touch input in each of both side areas of a touch panel, the processor 120 may detect that it is gripped by the user. Additionally or alternatively, when there is a touch input in each of both side areas of a touch panel, the electronic device 100 may detect that it is gripped by the user based on a touch area associated with the touch input (e.g., the size of the portion of the touch panel that has come in contact with the input object). According to various embodiments of the present disclosure, when there is a touch input in each of both side areas of a touch panel, the processor 120 may determine whether there is a grip state based on a pattern associated with the touch input (for example, a touch input of the thumb in one side area and a touch input of a plurality of fingers in the other side area). According to various embodiments of the present disclosure, even if there is a touch input in only one of the side areas, when there is a touch input of greater than a predetermined area or a touch input of a predetermined pattern, the processor 120 may determine this as a grip state.

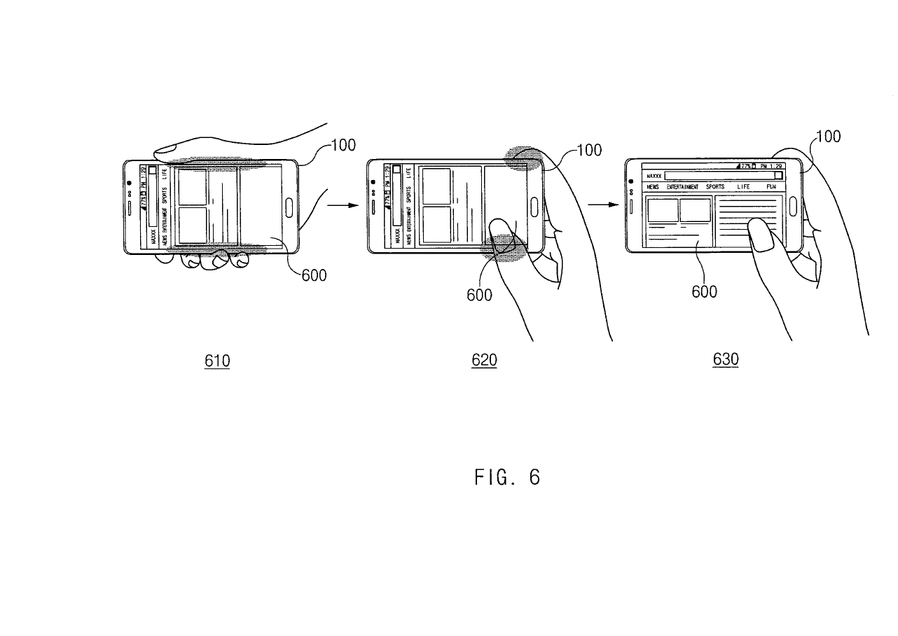

FIG. 6 is a diagram illustrating an example of a technique for enabling automatic screen rotation, according to various embodiments of the present disclosure. Operation 610 may correspond to operation 520 and operation 530 of FIG. 5. As shown in FIG. 5, in operation 610, the internet browser 600 displayed on the screen of the electronic device 100 may be displayed without rotation.

In operation 620, a user may change the grip. In more detail, after removing the hand, which grips the electronic device 100, from the electronic device 100, a user may change the grip and grip the electronic device 100 again as shown in operation 620.

In operation 630, while progressing from operation 610 to operation 620, the electronic device 100 may detect that the user's grip of the electronic device 100 is released. For example, the electronic device 100 may detect that the touch inputs received from the first area 210a and the third area 210b of the touch panel 200 disappear and based on this, rotate the screen of the internet browser 600.

According to various embodiments of the present disclosure, the electronic device 100 may rotate the screen of the internet browser 600 in response to detecting that the pattern of the touch inputs on the first area 210a and the third area 210b of the touch panel 200 is changed.

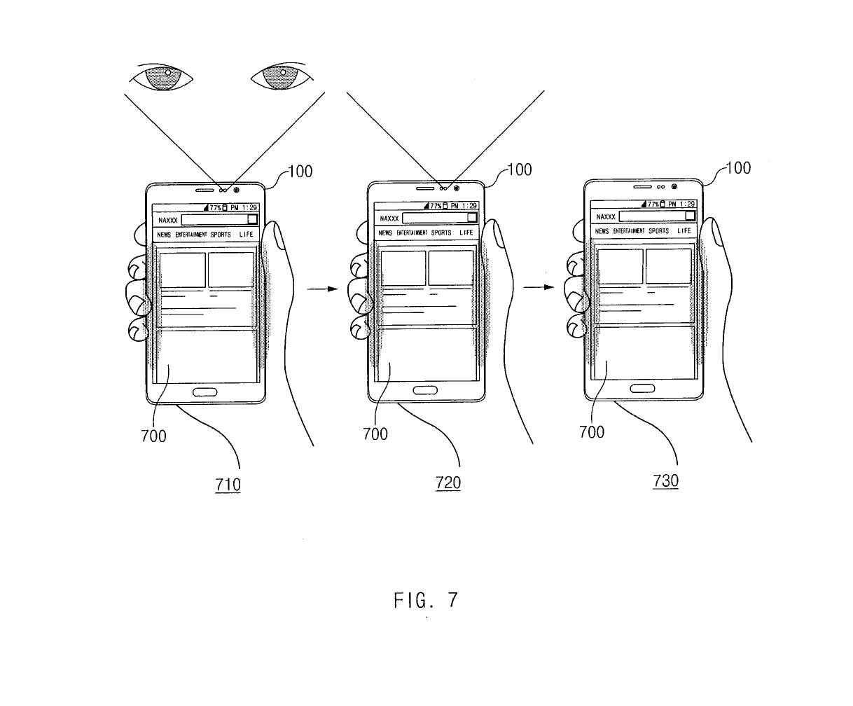

FIG. 7 is a diagram of an example of a technique for automatically deactivating a screen of an electronic device, according to various embodiments of the present disclosure.

In operation 710, the electronic device 100 may display an internet browser 700 on a screen while being gripped by a user and detect a user's gaze. The user's gaze may be detected by using an infrared sensor or an image sensor.

In operation 720, as a user's face position or direction is changed, the electronic device 100 may not be able to detect the user's gaze anymore.

The electronic device 100 may determine whether a predetermined timeout period has expired and execute a dimming procedure in which the screen is dimmed to a predetermined level, for a predetermined time (for example, 7 sec), before the screen is turned off. The electronic device 100 may attempt to detect a user's gaze through the infrared sensor or the image sensor before executing the dimming the routine. When the user's gaze is detected, the electronic device 100 may maintain the brightness level of the screen, and when no user's gaze is detected, the electronic device 100 may execute the dimming routine.

However, in operation 730, when a user's grip state is detected, the electronic device 100 may maintain the brightness of the screen even if a user's gaze cannot be detected. If a user's grip state is detected, even when a user's gaze is not detected, it may seem that a user is using the electronic device 100. The reason is that the infrared or image sensor does not accurately detect changes in user's face direction.

Compared to a case using the infrared or image sensor, the electronic device 100 maintains the brightness of the screen by using a touch panel having less power consumption, so that there is an advantage in terms of power management.

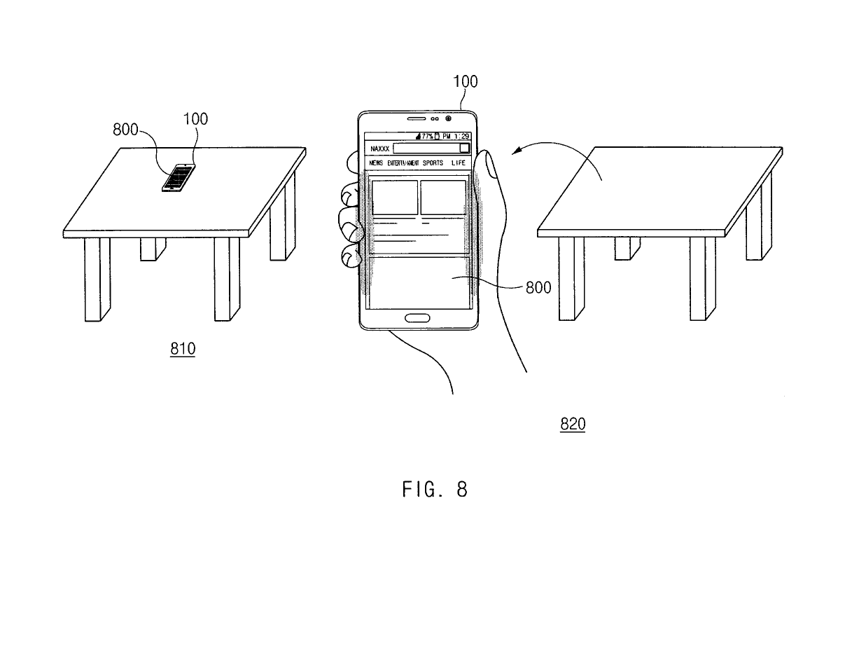

FIG. 8 is a diagram of an example of a technique for automatically activating a screen of an electronic device, according to various embodiments of the present disclosure.

In operation 810, the screen of the electronic device 100 may be in an off state 800.

In operation 820, the electronic device 100 may be lifted by a user. When the electronic device 100 is lifted, the electronic device 100 may recognize a user's grip state and may recognize an angle change by using a sensor included in the electronic device 100. The electronic device 100 may automatically switch the screen of the electronic device 100 into an on state based on the recognition of the user's grip state and the angle change.

In some aspects, it may be inefficient for the screen of the electronic device to be switched on only based a user's grip state. For example, when a user grips the electronic device 100 on a table to put it in a bag, if the screen becomes an on state, power is wasted unnecessarily. Therefore, according to various embodiments of the present disclosure, when an angle of the electronic device 100 relative to the ground reaches a predetermined level or a user's gaze is recognized, the electronic device 100 may switch the screen to an on state.

According to various embodiments of the present disclosure, the switching of the screen of the electronic device 100 to the on state automatically may be performed in a sensor hub MCU. For example, in a low power state that an AP is deactivated, the sensor hub MCU may detect a user's grip state and an angle change, and based on this, switch the screen of the electronic device 100 to an on state while maintaining the low power state.

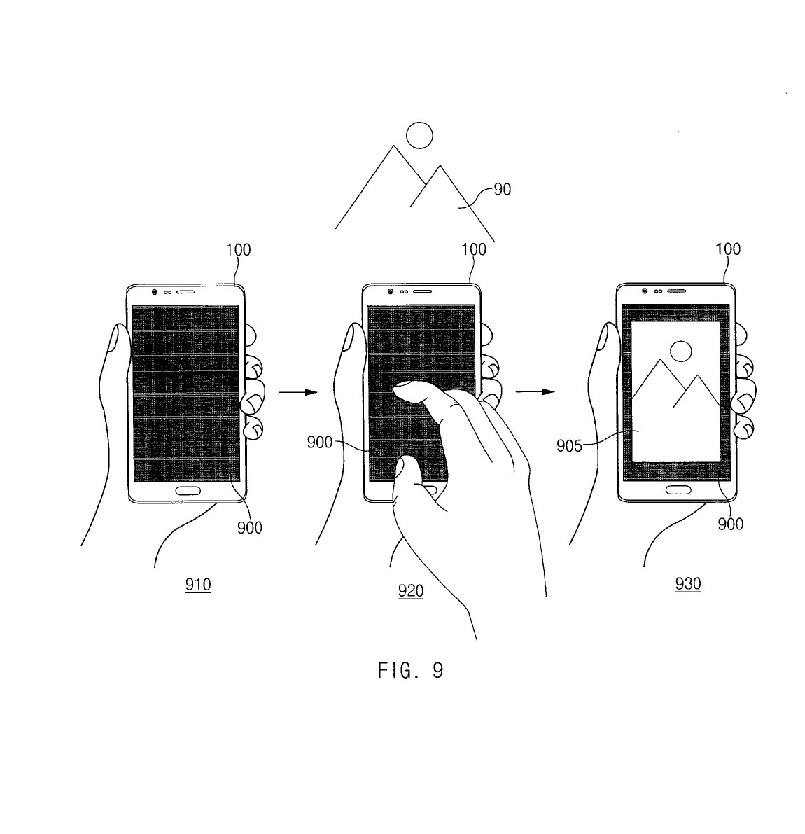

FIG. 9 is a diagram of an example of a technique for capturing images, according to various embodiments of the present disclosure.

In operation 910, the screen of the electronic device 100 may be in an off state 900 and the electronic device 100 may recognize a user's grip state.

In operation 920, the electronic device 100 may receive a predetermined touch input through the second area 220 of the touch panel 200. However, in operation 920, a newly received touch input is not limited to the second area 220. For example, the new touch input may be an input for the first area 210a or the third area 210b.

In operation 930, the electronic device 100 may activate an image sensor and capture an image 905 of a subject 90 based on the new touch input received in operation 920. The captured image 905 may be displayed on the screen of the electronic device 100.

According to various embodiments of the present disclosure, after the new touch input is received in operation 920, the screen of the electronic device 100 may be activated, and a preview image may be displayed on it.

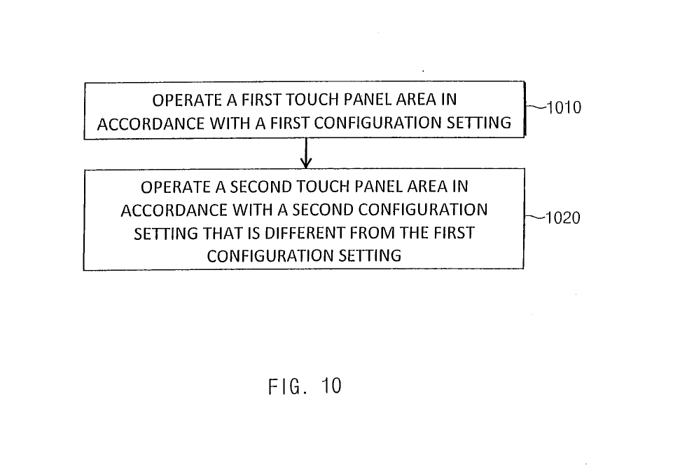

FIG. 10 is a flowchart of an example of a process, according to various embodiments of the present disclosure.

In operation 1010, the electronic device 100 may operate a first area of the touch panel in accordance with a first configuration setting.

In operation 1020, the electronic device 100 may operate a second area of the touch panel in accordance with a second configuration setting.

According to various embodiments of the present disclosure, a method performed in an electronic may include: detecting a first area of a touch panel of the electronic device with a first sensitivity; and detecting a second area of the touch panel with a second sensitivity different from the first sensitivity.

According to various embodiments of the present disclosure, the method may further include: detecting the first area with a first frequency; and detecting the second area with a second frequency.

According to various embodiments of the present disclosure, the method may further include: detecting the first area with a first sensitivity gain; and detecting the second area with a second sensitivity gain.

According to various embodiments of the present disclosure, the method may further include: detecting the first area with a first resolution; and detecting the second area with a second resolution.

According to various embodiments of the present disclosure, the method may further include: receiving an input from an input object through the first area; and displaying a specified function through a display based on the received input.

According to various embodiments of the present disclosure, the method may further include determining whether the received input is a grip for the electronic device and the specified function may be different based on whether the input is a grip operation for the electronic device.

According to various embodiments of the present disclosure, the method may further include, when the input is the grip operation for the electronic device, maintaining a specified function display through the display based on at least a part of the grip determination of the electronic device.

According to various embodiments of the present disclosure, the method may further include, when the input is not the grip operation for the electronic device, preventing the specified function display after a specified time.

According to various embodiments of the present disclosure, the first area may be formed in at least a part of a curved area of the touch panel.

According to various embodiments of the present disclosure, the first area may be disposed in at least a part of a display area of a display and a second area may be disposed in a non-display area of the display.

An electronic device according to various embodiments of the present disclosure may include a touch panel where at least one input object contacts or approaches; and at least one processor electrically connected to the touch panel. In this case, the at least one processor recognizes at least one input object that contacts or approaches the touch panel, and a sensitivity for recognizing the at least one input object when the at least one input object contacts or approaches a first area of the touch panel may be set different from a sensitivity for recognizing the at least one input object when the at least one input object contacts or approaches a second area of the touch panel.

According to various embodiments of the present disclosure, the at least one processor may detect the at least one input object in the first area by using a first frequency and detect the at least one input object in the second area by using a second frequency.

According to various embodiments of the present disclosure, the at least one processor may detect the at least one input object in the first area during a first time and detect the at least one input object in the second area during a second time.

According to various embodiments of the present disclosures, the at least one processor may include at least one of a touch screen panel (TSP) IC, an application processor (AP), and a microcontroller unit (MCU).

According to various embodiments of the present disclosure, a sensor electrically connected to the at least one processor may be further included. In this case, when at least one input object is recognized through the first area, the at least one processor may recognize a sensing value measured through the sensor and provide a predetermined effect.

According to various embodiments of the present disclosure, when the sensing value measured through the sensor is a value within a predetermined range of an angle of the electronic device, the provided predetermined effect may activate the screen in off state to an on state.

According to various embodiments of the present disclosure, when the sensing value measured through the sensor is greater than a predetermined change value for an angle of the electronic device, the provided predetermined effect may not rotate a screen displayed on a screen in on state.

According to various embodiments of the present disclosure, when the at least one input object recognized through the first area is not recognized anymore, the at least one processor may rotate the screen in on state.

According to various embodiments of the present disclosure, when the sensing value measured through the sensor is a time elapse value for automatically dimming the brightness of a screen, the provided predetermined effect may maintain the brightness of the screen.

According to various embodiments of the present disclosure, in relation to the provided predetermined effect, the maintaining of the brightness of the screen may be performed after the at least one processor recognizes the user's at least one eye.

According to various embodiments of the present disclosure, the first area may be formed in at least a part of a curved area of the touch panel.

According to various embodiments of the present disclosure, the first area may be located in a non-display area of a screen of the electronic device and at least a part of the second area may be located in a display area of the screen.

According to various embodiments of the present disclosure, the first area may be disposed at facing two borders of the touch screen panel and the second area may be disposed at the touch screen panel instead of the first area.

According to various embodiments of the present disclosure, a method performed in an electronic device may include detecting whether there is at least one input object contacting or approaching a first area of a touch panel by using a first sensitivity; and detecting whether there is at least one input object contacting or approaching a second area of the touch panel by using a second sensitivity.

According to various embodiments of the present disclosure, the detecting of whether there is at least one input object contacting or approaching the first area of the touch panel by using the first sensitivity may be performed during a first time and the detecting of whether there is at least one input object contacting or approaching the second area of the touch panel by using the second sensitivity may be performed for a second time.

According to various embodiments of the present disclosure, the method may include recognizing at least one input object through the first area; sensing a specific value through a sensor when at least one input object is recognized through the first area; and providing a predetermined effect based on the sensed value.

According to various embodiments of the present disclosure, when a value sensed through the sensor is a value within a predetermined range of an angle of the electronic device, the provided predetermined effect may activate the screen in off state to an on state.

According to various embodiments of the present disclosure, when a value sensed through the sensor is greater than a predetermined change value for an angle of the electronic device, the provided predetermined effect may not rotate a screen displayed on a screen in on state.

According to various embodiments of the present disclosure, when a value sensed through the sensor is a time elapse value for automatically dimming the brightness of a screen, the provided predetermined effect may maintain the brightness of the screen.

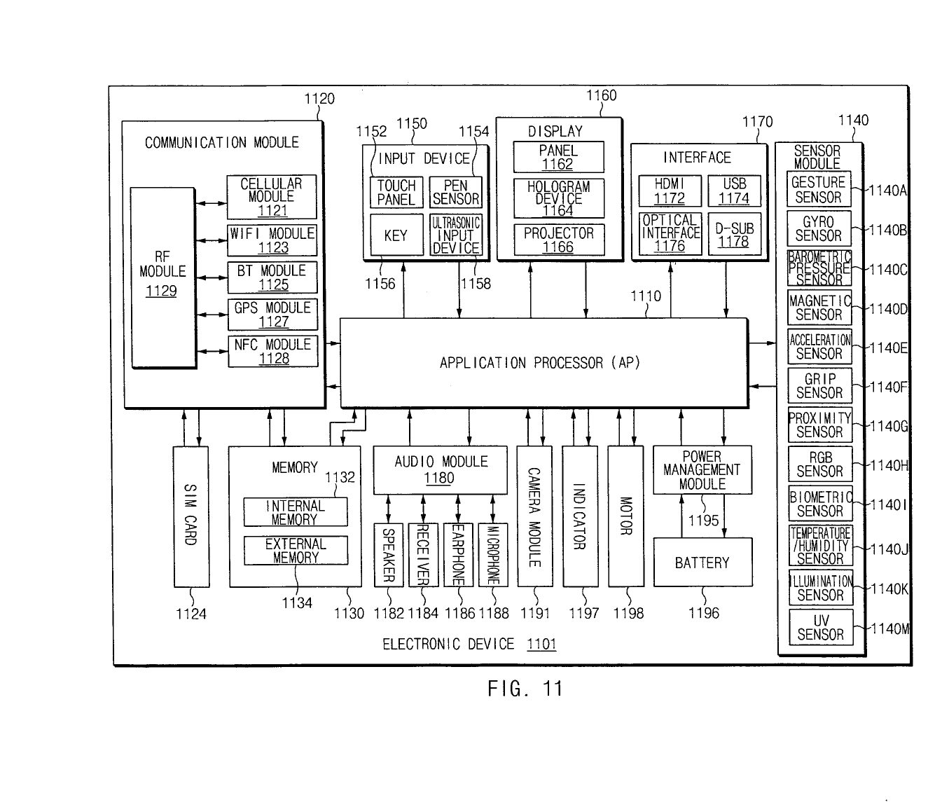

FIG. 11 is a block diagram of an example of an electronic device, according to various embodiments of the present disclosure. The electronic device 1101, for example, may include all or part of the electronic device 100 shown in FIG. 1. The electronic device 1101 may include at least one processor (for example, an application processor (AP)) 1110, a communication module 1120, a subscriber identification module (SIM) 1124, a memory 1130, a sensor module 1140, an input device 1150, a display 1160, an interface 1170, an audio module 1180, a camera module 1191, a power management module 1195, a battery 1196, an indicator 1197, and a motor 1198.

The processor 1110 may control a plurality of hardware or software components connected thereto and also may perform various data processing and operations by executing an operating system or an application program. The processor 1110 may be implemented with a system on chip (SoC), for example. According to an embodiment of the present disclosure, the processor 1110 may further include a graphic processing unit (GPU) (not shown) and/or an image signal processor. The processor 1110 may include at least part (for example, the cellular module 1121) of components shown in FIG. 11. The processor 1110 may load commands or data received from at least one of other components (for example, nonvolatile memory) and process them and may store various data in a nonvolatile memory.

The communication module 1120 may have the same or similar configuration to the communication interface 170 of FIG. 1. The communication module 1120 may include a cellular module 1121, a WiFi module 1123, a BT module 1125, a GNSS module 1127 (for example, a GPS module, a Glonass module, a Beidou module, or a Galileo module), an NFC module 1128, and a radio frequency (RF) module 1129.

The cellular module 1121, for example, may provide voice call, video call, text service, or internet service through communication network. According to an embodiment of the present disclosure, the cellular module 1121 may perform a distinction and authentication operation on the electronic device 1101 in a communication network by using a SIM (for example, a SIM card) 1124. According to an embodiment of the present disclosure, the cellular module 1121 may perform at least part of a function that the processor 1110 provides. According to an embodiment of the present disclosure, the cellular module 1121 may include a communication processor (CP).

Each of the WiFi module 1123, the BT module 1125, the GNSS module 1127, and the NFC module 1128 may include a processor for processing data transmitted/received through a corresponding module. According to an embodiment of the present disclosure, at least part (for example, at least one) of the cellular module 1121, the WiFi module 1123, the BT module 1125, the GNSS module 1127, and the NFC module 1128 may be included in one integrated chip (IC) or IC package.

The RF module 1129, for example, may transmit/receive communication signals (for example, RF signals). The RF module 1129, for example, may include a transceiver, a power amp module (PAM), a frequency filter, a low noise amplifier (LNA), or an antenna. According to another embodiment of the present disclosure, at least one of the cellular module 1121, the WiFi module 1123, the BT module 1125, the GNSS module 1127, and the NFC module 1128 may transmit/receive RF signals through a separate RF module.

The SIM 1124, for example, may include a card including a SIM and/or an embedded SIM and also may include unique identification information (for example, an integrated circuit card identifier (ICCID)) or subscriber information (for example, an international mobile subscriber identity (IMSI)).

The memory 1130 (for example, the memory 130) may include an internal memory 1132 or an external memory 1134. The internal memory 1132 may include at least one of a volatile memory (for example, dynamic RAM (DRAM), static RAM (SRAM), synchronous dynamic RAM (SDRAM)) and a non-volatile memory (for example, one time programmable ROM (OTPROM), programmable ROM (PROM), erasable and programmable ROM (EPROM), electrically erasable and programmable ROM (EEPROM), mask ROM, flash ROM, flash memory (for example, NAND flash or NOR flash), hard drive, and solid state drive (SSD)).

The external memory 1134 may further include a flash drive, for example, compact flash (CF), secure digital (SD), micro Micro-SD, Mini-SD, extreme digital (xD), multimedia card (MMC) or a memory stick. The external memory 1134 may be functionally and/or physically connected to the electronic device 1101 through various interfaces.

The sensor module 1140 measures physical quantities or detects an operating state of the electronic device 1101, thereby converting the measured or detected information into electrical signals. The sensor module 1140 may include at least one of a gesture sensor 1140A, a gyro sensor 1140B, a barometric pressure sensor 1140C, a magnetic sensor 1140D, an acceleration sensor 1140E, a grip sensor 1140F, a proximity sensor 1140G a color sensor 1140H (for example, a red, green, blue (RGB) sensor), a biometric sensor 1140I, a temperature/humidity sensor 1140J, an illumination sensor 1140K, and an ultraviolet (UV) sensor 1140M. Additionally or alternatively, the sensor module 1140 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1140 may further include a control circuit for controlling at least one sensor therein. According to an embodiment of the present disclosure, the electronic device 1101 may further include a processor configured to control the sensor module 1140 as part of or separately from the processor 1110 and thus may control the sensor module 1140 while the processor 1110 is in a sleep state.

The input device 1150 may include a touch panel 1152, a (digital) pen sensor 1154, a key 1156, or an ultrasonic input device 1158. The touch panel 1152 may use at least one of capacitive, resistive, infrared, or ultrasonic methods, for example. Additionally, the touch panel 1152 may further include a control circuit. The touch panel 1152 may further include a tactile layer to provide a tactile response to a user.

The (digital) pen sensor 1154, for example, may include a sheet for recognition as part of a touch panel or a separate sheet for recognition. The key 1156 may include a physical button, an optical key, or a keypad, for example. The ultrasonic input device 1158 may detect ultrasonic waves generated from an input tool through a microphone (for example, the microphone 1188) in order to check data corresponding to the detected ultrasonic waves.

The display 1160 (for example, the display 160) may include a panel 1162, a hologram device 1164, or a projector 1166. The panel 1162 may have the same or similar configuration to the display 140 of FIG. 1. The panel 1162 may be implemented to be flexible, transparent, or wearable, for example. The panel 1162 and the touch panel 1152 may be configured with one module. The hologram 1164 may show three-dimensional images in the air by using the interference of light. The projector 1166 may display an image by projecting light onto a screen. The screen, for example, may be placed inside or outside the electronic device 1101. According to an embodiment of the present disclosure, the display 1160 may further include a control circuit for controlling the panel 1162, the hologram device 1164, or the projector 1166.

The interface 1170 may include a high-definition multimedia interface (HDMI) 1172, a universal serial bus (USB) 1174, an optical interface 1176, or a D-subminiature (sub) 1178 for example. The interface 1170, for example, may be included in the communication interface 170 shown in FIG. 1. Additionally or alternatively, the interface 1170 may include a mobile high-definition link (MHL) interface, a secure Digital (SD) card/multi-media card (MMC) interface, or an infrared data association (IrDA) standard interface.

The audio module 1180 may convert sound into electrical signals and convert electrical signals into sounds. At least some components of the audio module 1180, for example, may be included in the input/output interface 140 shown in FIG. 1. The audio module 1180 may process sound information inputted/outputted through a speaker 1182, a receiver 1184, an earphone 1186, or a microphone 1188.

The camera module 1191, as a device for capturing a still image and a video, may include at least one image sensor (for example, a front sensor or a rear sensor), a lens, an image signal processor (ISP), or a flash (for example, an LED or a xenon lamp).

The power management module 1195 may manage the power of the electronic device 1101. According to an embodiment of the present disclosure, the power management module 1195 may include a power management IC (PMIC), a charger IC, or a battery or fuel gauge, for example. The PMIC may have a wired and/or wireless charging method. As the wireless charging method, for example, there is a magnetic resonance method, a magnetic induction method, or an electromagnetic method. An additional circuit for wireless charging, for example, a circuit such as a coil loop, a resonant circuit, or a rectifier circuit, may be added. The battery gauge may measure the remaining amount of the battery 1196, or a voltage, current, or temperature thereof during charging. The battery 1196, for example, may include a rechargeable battery and/or a solar battery.

The indicator 1197 may display a specific state of the electronic device 1101 or part thereof (for example, the processor 1110), for example, a booting state, a message state, or a charging state. The motor 1198 may convert electrical signals into mechanical vibration and may generate vibration or haptic effect. Although not shown in the drawings, the electronic device 1101 may include a processing device (for example, a GPU) for mobile TV support. A processing device for mobile TV support may process media data according to the standards such as digital multimedia broadcasting (DMB), digital video broadcasting (DVB), or mediaFLO™.

According to various embodiments of the present disclosure, an electronic device and method may recognize an object in each area of a touch panel of the electronic device by using a different sensitivity. Through this, a case that at least one input object approaches or contacts a specified area may be adjusted to be detected better or worse in comparison to a case that the at least one input object approaches or contacts another specified area different from the specified area.

Each of the above-mentioned components of the electronic device according to various embodiments of the present disclosure may be configured with at least one component and the name of a corresponding component may vary according to the kind of an electronic device. According to various embodiments of the present disclosure, an electronic device according to various embodiments of the present disclosure may include at least one of the above-mentioned components, may not include some of the above-mentioned components, or may further include another component. Additionally, some of components in an electronic device according to various embodiments of the present disclosure are configured as one entity, so that functions of previous corresponding components are performed identically.

The term “module” used in various embodiments of the present disclosure, for example, may mean a unit including a combination of at least one of hardware, software, and firmware. The term “module” and the term “unit”, “logic”, “logical block”, “component”, or “circuit” may be interchangeably used. A “module” may be a minimum unit or part of an integrally configured component. A “module” may be a minimum unit performing at least one function or part thereof. A “circuit” may be implemented mechanically or electronically. For example, “circuit” according to various embodiments of the present disclosure may include at least one of an application-specific integrated circuit (ASIC) chip performing certain operations, field-programmable gate arrays (FPGAs), or a programmable-logic device, all of which are known or to be developed in the future.

According to various embodiments of the present disclosure, at least part of a device (for example, modules or functions thereof) or a method (for example, operations) according to this disclosure, for example, as in a form of a programming module, may be implemented using an instruction stored in computer-readable storage media. When at least one processor (for example, the processor 130) executes an instruction, it may perform a function corresponding to the instruction. The non-transitory computer-readable storage media may include the memory 130, for example.

According to various embodiments of the present disclosure, in relation to a computer readable medium where an instruction executed by at least one processor and readable by a computer is stored, the instruction may include detecting whether at least one input object contacting or approaching a first area of a touch panel by using a first sensitivity; and detecting whether at least one input object contacting or approaching a second area of the touch panel by using a second sensitivity.

FIGS. 1-11 are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

What is claimed is:

1. An electronic device comprising:
a touch panel; and
a touch sensing controller configured to:
operate at least one first area of the touch panel in accordance with a first sensitivity configuration setting; and
operate at least one second area of the touch panel in accordance with a second sensitivity configuration setting that is different from the first sensitivity configuration setting,
wherein the at least one first area is adjacent to at least one side edge of the touch panel and a touch sensitivity of the at least one first area is lower than the touch sensitivity of the at least one second area.

2. The electronic device of claim 1, wherein:
operating the at least one first area in accordance with the first sensitivity configuration setting includes operating the at least one first area in accordance with a first sampling frequency, and
operating the at least one second area in accordance with the second sensitivity configuration setting includes operating the at least one second area in accordance with a second sampling frequency.

3. The electronic device of claim 1, wherein:
operating the at least one first area in accordance with the first sensitivity configuration setting includes operating the at least one first area in accordance with a first sensitivity gain, and
operating the at least one second area in accordance with the second sensitivity configuration setting includes operating the at least one second area in accordance with a second sensitivity gain.

4. The electronic device of claim 1, wherein:
operating the at least one first area in accordance with the first sensitivity configuration setting includes operating the at least one first area in accordance with a first detection time, and
operating the at least one second area in accordance with the second sensitivity configuration setting includes operating the at least one second area in accordance with a second detection time.

5. The electronic device of claim 1, further comprising a display, wherein the touch sensing controller is further configured to receive an input through the at least one first area and display a screen on the display based on the input.

6. The electronic device of claim 5, wherein:
the touch sensing controller is further configured to detect whether the input is associated with a grip, and operate different function of the screen based on whether the input is associated with the grip.

7. The electronic device of claim 6, wherein operating different function of the screen based on whether the input is associated with the grip includes maintaining a display of the screen when the input is associated with the grip.

8. The electronic device of claim 6, wherein operating different function of the screen based on whether the input is associated with the grip includes turning off the display after a specified time when the input is not associated with the grip.

9. The electronic device of claim 1, wherein the at least one first area is located in a curved portion of the touch panel.

10. The electronic device of claim 1, further comprising a display, wherein the at least one first area is located in a viewable portion of the display and the at least one second area is located in a non-viewable portion of the display.

11. A method comprising:
operating at least one first area of a touch panel of an electronic device in accordance with a first sensitivity configuration setting; and
operating at least one second area of the touch panel in accordance with a second sensitivity configuration setting that is different from the first sensitivity configuration setting,
wherein the at least one first area is adjacent to at least one side edge of the touch panel and a touch sensitivity of the at least one first area is lower than the touch sensitivity of the at least one second area.

12. The method of claim 11, wherein:
operating the at least one first area in accordance with the first sensitivity configuration setting includes operating the at least one first area in accordance with a first sampling frequency, and
operating the at least one second area in accordance with the second sensitivity configuration setting includes operating the at least one second area in accordance with a second sampling frequency.

13. The method of claim 11, wherein:
operating the at least one first area in accordance with the first sensitivity configuration setting includes operating the at least one first area in accordance with a first sensitivity gain, and
operating the at least one second area in accordance with the second sensitivity configuration setting includes operating the at least one second area in accordance with a second sensitivity gain.

14. The method of claim 11, wherein:
operating the at least one first area in accordance with the first sensitivity configuration setting includes operating the at least one first area in accordance with a first detection time, and
operating the at least one second area in accordance with the second sensitivity configuration setting includes operating the at least one second area in accordance with a second detection time.

15. The method of claim 11, further comprising receiving an input through the at least one first area and displaying a screen on a display of the electronic device based on the input.

16. The method of claim 15, further comprising detecting whether the input is associated with a grip, and
operating different function of the screen based on whether the input is associated with the grip.

17. The method of claim 16, wherein operating different function of the screen based on whether the input is associated with the grip includes maintaining a display of the screen when the input is associated with the grip.

18. The method of claim 16, wherein operating different function of the screen based on whether the input is associated with the grip includes turning off the display after a specified time when the input is not associated with the grip.

19. The method of claim 11, wherein the at least one first area is located in a curved portion of the touch panel.

20. The method of claim 11, wherein the at least one first area is located in a viewable portion of a display of the electronic device and the at least one second area is located in a non-viewable portion of the display.

21. A non-transitory computer-readable medium storing one or more processor-executable instructions which when executed by at least one processor of an electronic device cause the at least one processor to execute a method comprising the steps of:
operating at least one first area of a touch panel of an electronic device in accordance with a first sensitivity configuration setting; and
operating at least one second area of the touch panel in accordance with a second sensitivity configuration setting that is different from the first sensitivity,
wherein the at least one first area is adjacent to at least one side edge of the touch panel and a touch sensitivity of the at least one first area is lower than the touch sensitivity of the at least one second area.
